(19) United States
(12) Patent Application Publication
(10) Pub. No.: US 2025/0132307 A1
(43) Pub. Date: Apr. 24, 2025

(54) COMPOSITE CATHODE ACTIVE MATERIAL PARTICLE FOR LITHIUM ION BATTERY, CATHODE ACTIVE MATERIAL LAYER, LITHIUM ION BATTERY, AND METHOD FOR PRODUCING COMPOSITE CATHODE ACTIVE MATERIAL PARTICLE FOR LITHIUM ION BATTERY

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 18/768,437

(22) Filed: Jul. 10, 2024

(30) Foreign Application Priority Data
Oct. 23, 2023 (JP) 2023-181754

(51) Int. Cl. H01M 4/131; H01M 4/62; H01M 10/0525

(52) U.S. Cl. CPC H01M 4/131; H01M 4/62; H01M 10/0525

(57) ABSTRACT

The composite cathode active material particles for a lithium ion battery of the present disclosure have a cathode active material and lithium alloy particles having a lithium alloying potential of 0.5 V (vs Li/Li+) or more and/or metal particles generated by desorption of lithium from the lithium alloy particles, and the lithium alloy particles or the metal particles are dispersed in the cathode active material.

### CROSS-REFERENCE TO RELATED APPLICATION

This application claims priority to Japanese Patent Application No. 2023-181754 filed on Oct. 23, 2023, incorporated herein by reference in its entirety.

### BACKGROUND

### 1. Technical Field

The present disclosure relates to a composite cathode active material particle for a lithium ion battery, a cathode active material layer, a lithium ion battery, and a method for producing the composite cathode active material particle for the lithium ion battery.

### 2. Description of Related Art

Hitherto, active materials for lithium ion batteries have been improved in order to increase the capacity.

Japanese Unexamined Patent Application Publication No. 2014-010991 (JP 2014-010991 A) discloses an electrode for use in a non-aqueous electrolyte secondary battery. The specific surface area of an anode active material of the electrode, measured by the N₂ adsorption method, is 3.3 m²/g or more and 4.4 m²/g or less. The dibutyl phthalate (DBP) oil absorption of a cathode active material of this electrode is 30 ml/100 g or more and 47 ml/100 g or less. The cathode density is 1.8 g/cm³ or more and 2.2 g/cm³ or less. JP 2014-010991 A discloses that the capacity of the anode is increased by using a lithium (Li) alloy as an active material.

Lithium nickel cobalt manganese (NCM) oxide is widely used as a cathode active material, and an improvement in composition of the lithium NCM oxide has been studied.

### SUMMARY

When related-art electrodes such as the electrode of JP 2014-010991 A are used, a significant decrease in capacity is sometimes observed after initial charging. In addition, batteries are required to have good cycle characteristics, that is, to suppress a decrease in capacity in a case where charging and discharging are repeated.

Therefore, the present disclosure provides a composite cathode active material particle for a lithium ion battery that can suppress a decrease in capacity in a case where charging and discharging are repeated while suppressing a decrease in capacity after initial charging.

The inventors of the present disclosure found through intensive studies that the above problem could be solved by the following means, and completed the present disclosure. The present disclosure is as follows.

### First Aspect

A composite cathode active material particle for a lithium ion battery, the composite cathode active material particle including:
a cathode active material; and
lithium alloy particles having a lithium alloying potential of 0.5 V (vs Li/Li⁺) or more and/or metal particles generated by desorption of lithium from the lithium alloy particles, in which the lithium alloy particles or the metal particles are dispersed in the cathode active material.

### Second Aspect

The composite cathode active material particle according to the first aspect, in which the lithium alloy particles are selected from the group consisting of Li₃Bi, Li₃Sb, and LiSn.

### Third Aspect

The composite cathode active material particle according to the first or second aspect, in which
the cathode active material is lithium nickel cobalt manganese oxide.

### Fourth Aspect

A cathode active material layer including
the composite cathode active material particle according to any one of the first to third aspects.

### Fifth Aspect

A lithium ion battery including
the cathode active material layer according to the fourth aspect.

### Sixth Aspect

A method for manufacturing a lithium ion battery, the method including:
producing a composite cathode active material particle precursor for the lithium ion battery that contains a cathode active material and lithium alloy particles dispersed in the cathode active material and having a lithium alloying potential of 0.5 V (vs Li/Li⁺) or more;
producing a cathode precursor layer containing at least the composite cathode active material particle precursor for the lithium ion battery;
obtaining a lithium ion battery precursor including the cathode precursor layer, a separator or a solid electrolyte layer, and an anode active material layer in a stated order and impregnated with an electrolytic solution; and
performing initial charging of the lithium ion battery precursor to change the cathode precursor layer into a cathode active material layer.

According to the present disclosure, it is possible to provide the composite cathode active material particle for the lithium ion battery that can suppress the decrease in capacity in the case where charging and discharging are repeated while suppressing the decrease in capacity after the initial charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a composite cathode active material particle for a lithium ion battery according to the present disclosure; and

FIG. 2 is a schematic diagram of a lithium ion battery of the present disclosure.

### DETAILED DESCRIPTION OF EMBODIMENTS

### Composite Cathode Active Material Particles for Lithium Ion Batteries

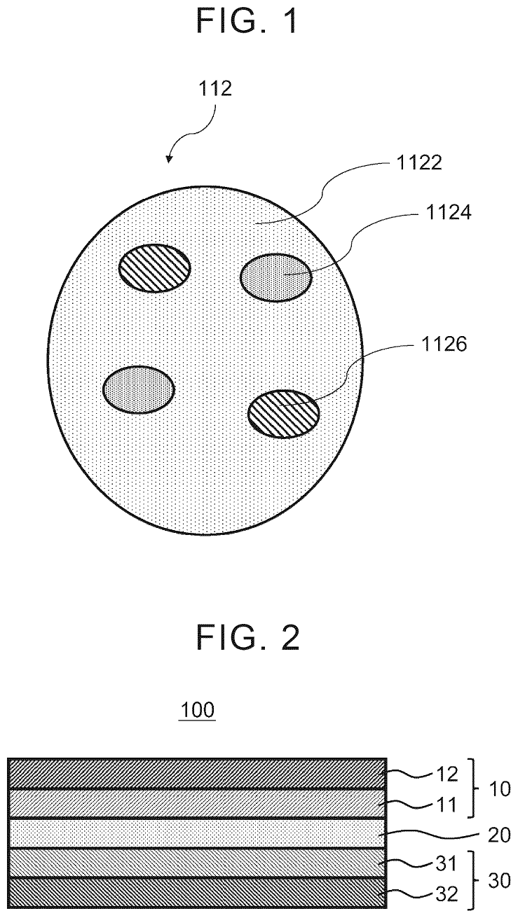

As shown in FIG. 1, a composite cathode active material particle 112 for a lithium ion battery of the present disclosure includes:
cathode active material 1122, and
lithium alloy particles 1124 having a lithium alloying potential of 0.5 V (vs Li/Li⁺) or more and/or the metal particles 1126 formed by desorption of lithium from the lithium alloy are contained.

The lithium alloy particles 1124 or the metal particles 1126 are dispersed in the cathode active material 1122.

The inventors of the present disclosure have found that the reason for the decrease in the battery capacity described in JP 2014-010991 A is that lithium supplied in the initial cathode active material is consumed in order to form SEI (Solid Electrolyte Interphase) in the negative electrode during the initial charge.

On the other hand, the inventors of the present disclosure have found that the capacity can be improved by obtaining a lithium ion battery by using the above-described composite cathode active material particles for a lithium ion battery as a cathode precursor layer. Without wishing to be bound by theory, the inventors of the present disclosure believe that the reasons for capacity improvement are as follows. Since the lithium of the lithium alloy in the cathode precursor layer is released during the first charge and becomes the lithium consumed for forming SEI in the negative electrode, it is possible to prevent the lithium in the cathode active material from being consumed for forming SEI. In addition, it is considered that when the lithium alloying potential of the lithium alloy is equal to or higher than 0.5 V (vs Li/Li⁺), it is possible to prevent the electrochemical reaction from occurring inside the positive electrode precursors before the initial charge.

On the other hand, when the lithium alloy particles are used as they are, there is a problem that the cycle characteristics are not good, and when the charging and discharging are repeatedly performed, the capacity may be greatly reduced with a small number of times of charging and discharging. The inventors of the present disclosure have found that the cause is that the metal constituting the lithium alloy particles locally becomes a high concentration of metal ions when oxidized and dissolved at the time of charging, and this is a point in which the metal ions concentratedly precipitate at one place in the negative electrode, resulting in resistance.

On the other hand, the inventors of the present disclosure have found that by dispersing the lithium alloy particles in the cathode active material, concentrated precipitation of the metal in the negative electrode is suppressed, thereby solving the above problem. While the inventors of the present disclosure do not wish to be bound by theory, the reason why the concentrated precipitation of the metal in the negative electrode is suppressed is considered as follows. In the composite cathode active material particles for a lithium ion battery of the present disclosure, the lithium passes through the active material and moves to the negative electrode due to charging, while the metal particles generated by desorption of the lithium remain in the active material, so that the concentrated precipitation of the metal in the negative electrode is suppressed.

That is, in the metal particles of the composite cathode active material particles for a lithium ion battery of the present disclosure, at least a part of the lithium alloy particles become metal particles when the lithium in the lithium alloy particles dispersed in the cathode active material is desorbed from the lithium alloy particles through initial charging.

Hereinafter, each component of the present disclosure will be described.

### Cathode Active Material

An optional cathode active material can be used as the cathode active material, and is not particularly limited, and for example, a lithium-containing oxide can be used.

The lithium-containing oxide as the cathode active material is not particularly limited, and may include, for example, at least Li, at least one transition-metal element selected from Co, Ni and Mn, and O. As such a lithium-containing oxide, for example, lithium cobalt oxide (LiCoO₂), Lithium nickel oxide (LiNiO₂), lithium manganese oxide (LiMn₂O₄), and lithium nickel cobalt manganese (NCM) oxide in which some of the elements are replaced with other elements can be used. Lithium NCM oxide is generally represented by the general formula LiₐMnₓNi_{y}Co_{z}O_{2αδ}(0<a≤1.5, 0≤x≤1.5, 0≤y≤1.5, 0≤z≤1.5, 0<δ(=x+y+z)<1.5), for example LiNi_{0.8}Co_{0.1}Mn_{0.1}O₂ (NCM811) or the like can be used. The lithium-containing oxide as the cathode active material may have, for example, an O₂ type structure, an O₃ type structure, or a crystalline structure other than these. As the cathode active material, only one kind may be used alone, or two or more kinds may be used in combination.

### Lithium Alloy Particles

The lithium alloy particles have a lithium alloying potential of 0.5 V (vs Li/Li⁺) or more.

The lithium alloying potential of the lithium alloy particles may be 0.6 V or more (vs Li/Li⁺), 0.7 V (vs Li/Li⁺) or more, or 0.8 V (vs Li/Li⁺) or more. It may be more, also 1.5 V (vs Li/Li⁺) or less, 1.4 V (vs Li/Li⁺) or less, 1.3 V (vs Li/Li⁺) or less, 1.2 V (vs Li/Li⁺) or less, 1.1 V (vs Li/Li⁺) or less, or 1.0 V (vs Li/Li⁺) or less.

Here, the lithium alloying potential (vs Li/Li⁺) is the electrode potential of the electrode reaction of the formula (1) and is expressed with reference to the electrode potential of the lithium of the formula (2) below:

xLi⁺+M+xe⁻←→LiₓM (1)

Li⁺+e⁻←→Li (2)

The lithium alloying potential (vs Li/Li⁺) can be measured as a unipolar potential obtained when the alloy is immersed in a salt solution of lithium.

For example, Li₃Bi, Li₃Sb, and LiSn can be used as the lithium alloy particle.

### Metal Particle

The metal particles of the composite cathode active material particles for a lithium ion battery of the present disclosure are metal particles generated by desorption of lithium from the above-described lithium alloy particles.

Examples of such metal particles include bismuth particles, antimony particles, and tin particles.

### Cathode Active Material Layer

The cathode active material layer contains the above-described composite cathode active material particles for a lithium ion battery. In addition, the cathode active material layer may contain an optional other material. Other materials include, for example, conductive auxiliaries and binders.

### Conductive Aid

As the conductive auxiliary agent optionally contained in the cathode precursor layer, one known as a conductive auxiliary agent used in a lithium ion battery may be used. Specifically, a carbon material such as Ketjen Black (KB), a vapor-phase carbon fiber (VGCF), acetylene black (AB), carbon nanotubes (CNT), carbon nanofibers (CNF), carbon black, coke, graphite, or the like may be used. Alternatively, a metal material capable of withstanding the environment when the battery is used may also be used. As the conductive auxiliary agent, only one kind may be used alone, or a combination of two or more kinds may be used. The shape of the conductive aid may be various shapes such as powdery, fibrous, and the like. The amount of the conductive auxiliary agent contained in the cathode active material layer is not particularly limited.

### Binder

As the binder optionally contained in the cathode precursor layer, a binder known as a binder used in a lithium ion battery may be used. For example, a styrene butadiene rubber (SBR)-based binder, a carboxymethyl cellulose (CMC)-based binder, an acrylonitrile butadiene rubber (ABR)-based binder, a butadiene rubber (BR)-based binder, a polyvinylidene fluoride (PVDF)-based binder, a polytetrafluoroethylene (PTFE)-based binder, and the like may be used. Only one binder may be used alone, or a combination of two or more binders may be used. The amount of the binder contained in the cathode active material layer is not particularly limited.

### A Lithium Ion Battery

The lithium ion battery of the present disclosure includes the cathode active material layer, the separator or the solid electrolyte layer, and the anode active material layer.

FIG. 1 schematically illustrates a configuration of a lithium ion battery 100 according to one embodiment of the present disclosure. As illustrated in FIG. 1, the lithium ion battery 100 may include a positive electrode 10, a separator 20, and a negative electrode 30. The positive electrode 10 may include the cathode active material layer 11 and the positive electrode current collector layer 12, and the negative electrode 30 may include the anode active material layer 31 and the negative electrode current collector layer 32. In this case, the cathode active material layer 11 may include the above-described cathode active material. The electrolyte may be included in the cathode active material layer 11 and the anode active material layer 31, although not shown.

In addition, when the lithium ion battery of the present disclosure is a solid-state battery, the lithium ion battery of the present disclosure may have a solid electrolyte layer present at this position instead of the separator 20.

Hereinafter, each component of the lithium ion battery of the present disclosure will be described.

### Positive Electrode Current Collector Layer

The positive electrode current collector layer may be formed of a known metal or the like that can be used as a positive electrode current collector of a lithium ion battery. Examples of such metals include metal materials containing at least one element selected from the group consisting of Cu, Ni, Al, V, Au, Pt, Mg, Fe, Ti, Pb, Co, Cr, Zn, Ge, In, Sn, Zr. The form of the positive electrode current collector is not particularly limited. Various forms such as foil, mesh, porous, and the like may be employed. The metal may be deposited and plated on the surface of the substrate.

### Separator

As the separator, a separator known as a separator used in a lithium ion battery may be used. For example, the separator may be made of a resin such as polyethylene (PE), polypropylene (PP), polyester, and polyamide. The separator may have a single-layer structure or a multi-layer structure. As the separator having a multilayer structure, for example, a separator having a multilayer structure composed of the above resin, for example, a separator having a PE/PP two-layer structure, a separator having a PP/PE/PP or PE/PP/PE three-layer structure, or the like can be used. The separator may be composed of a nonwoven fabric such as a cellulose nonwoven fabric, a resin nonwoven fabric, or a glass fiber nonwoven fabric. The thickness of the separator is not particularly limited, and may be, for example, 5 μm or more and 1 mm or less.

### Anode Active Material Layer

The anode active material layer contains a negative electrode active material. The anode active material layer may contain other optional components. Examples of the other components include a conductive auxiliary agent and a binder. As the conductive assistant and the binder, reference can be made to the description of the cathode active material layer.

### Anode Active Material Layer: Negative Electrode Active Material

As the negative electrode active material, various materials having a potential (charge-discharge potential) at which ions are occluded and released, which is a lower potential than the cathode active material described above, may be used. As the negative electrode active material, for example, a silicon-based active material such as Si, an Si alloy, silicon oxide, or the like; a carbon-based active material such as graphite, graphite, hard carbon, or the like; various oxide-based active materials such as lithium titanate; a metallic lithium, a lithium alloy, or the like may be used. Only one type of the negative electrode active material may be used alone, or two or more types may be used in combination.

### Negative Electrode Current Collector Layer

The negative electrode current collector layer may be formed of a known metal or the like that can be used as a negative electrode current collector of a lithium ion battery. Such a metal may be, for example, a metal material containing at least one element selected from the group consisting of Cu, Ni, Al, V, Au, Pt, Mg, Fe, Ti, Pb, Co, Cr, Zn, Ge, In, Sn, and Zr. The form of the negative electrode current collector layer is not particularly limited, and may be various forms such as a foil form, a mesh form, and a porous form. The negative electrode current collector layer may be formed by plating or depositing the metal on the surface of a substrate made of an optional material. The surface of the negative electrode current collector layer may be coated with a carbon material or the like.

### Nonaqueous Electrolyte

The non-aqueous electrolyte may contain a non-aqueous solvent and an electrolyte. The electrolytic solution may contain an alkali metal ion as a carrier ion, for example, a lithium ion.

As the non-aqueous solvent, a solvent other than water, for example, an organic solvent can be used. As the organic solvent, for example, a carbonate-based solvent such as ethylene carbonate (EC), dimethyl carbonate (DMC), ethyl methyl carbonate (EMC), or fluoroethylene carbonate (FEC) can be used. These organic solvents may be used singly or in combination.

The electrolyte is not particularly limited, and may be, for example, a lithium salt. For example, a LiPF₆ can be used as the lithium-salt.

### Solid Electrolyte Layer

The solid electrolyte layer may contain a solid electrolyte.

The material of the solid electrolyte is not particularly limited, and a material that can be used as a solid electrolyte used in a lithium ion battery can be used. For example, the solid electrolyte may be, but not limited to, a sulfide solid electrolyte, an oxide solid electrolyte, a polymer electrolyte, or the like. Further, these solid electrolytes, only one may be used alone, or two or more may be used in combination.

As the sulfide solid electrolyte, any sulfide solid electrolyte can be used. Specifically, examples of the sulfide solid electrolyte include a sulfide solid electrolyte such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, or Li₂S—P₂S₅—GeS₂.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but are not limited thereto. These may be amorphous or crystalline.

Examples of polymer electrolytes include polyethylene oxide (PEO), polypropylene oxide (PPO), copolymers thereof, and the like, but are not limited to these.

### Method for Manufacturing Lithium Ion Battery

A method of the present disclosure for obtaining a lithium ion battery comprises:
producing a composite cathode active material particle precursor for the lithium ion battery that contains a cathode active material and lithium alloy particles dispersed in the cathode active material and having a lithium alloying potential of 0.5 V (vs Li/Li⁺) or more;
Producing a cathode precursor layer containing at least a composite cathode active material particle precursor for a lithium ion battery,
Obtaining a lithium ion battery precursor having a cathode precursor layer, a separator or a solid electrolyte layer, and an anode active material layer in this order and impregnated with an electrolytic solution; and
performing initial charging of the lithium ion battery precursor to change the cathode precursor layer into a cathode active material layer.

### Include.

Hereinafter, each step of the method of the present disclosure will be described.

### Preparation of Composite Cathode Active Material Particle Precursor for Lithium Ion Battery

The composite cathode active material particle precursor for a lithium ion battery includes a cathode active material and/or lithium alloy particles dispersed in the cathode active material and having a lithium alloying potential of 0.5 V (vs Li/Li⁺) or more.

Preparation of the composite cathode active material particle precursor for a lithium ion battery can be performed by a method including the following in one embodiment:
Grinding the lithium alloy particles in an inert environment,
Dispersing the lithium alloy particles in the molten cathode active material, and then cooling and solidifying to produce a precursor block; and
The cooled precursor block is pulverized to obtain a composite cathode active material particle precursor for a lithium ion battery.

In another embodiment, the composite cathode active material particle precursor for a lithium ion battery may be prepared by a method including:
Grinding the lithium alloy particles in an inert environment,
Dispersing the lithium alloy particles in a material for obtaining a molten cathode active material, and cooling and solidifying to produce a precursor block; and
Grinding the cooled precursor block to obtain particles in which the lithium alloy particles are dispersed in one material;
Mixing and reacting the particles with the remaining material for obtaining the cathode active material to obtain a composite cathode active material particle precursor for a lithium ion battery.

As a material for obtaining the cathode active material, for example, a hydroxide, an oxide, a carbonate, or the like of a metal constituting the cathode active material can be used.

### Preparation of Cathode Precursor Layer

The cathode precursor layer contains at least a composite cathode active material particle precursor for a lithium ion battery. The cathode precursor layer may also contain other optional materials. Other materials include, for example, conductive auxiliaries and binders.

Preparation of the cathode precursor layer can be performed by mixing each material constituting this and coating.

### Preparation of Lithium Ion Battery Precursors

The lithium ion battery precursor has a cathode precursor layer, a separator or a solid electrolyte layer, and an anode active material layer in this order, and is impregnated with a non-aqueous electrolytic solution. The preparation of the lithium ion battery precursor may be performed by a known method.

The lithium ion battery precursor may further include a positive electrode current collector layer and a negative electrode current collector layer.

For each component of the lithium ion battery precursor, reference may be made to a description of a lithium ion battery.

### Preparation of Cathode Active Material Layer

The cathode active material layer is prepared by performing initial charging on the lithium ion battery precursor and forming the cathode precursor layer into a cathode active material layer. As a result, at least a part of the lithium of the lithium alloy particles in the composite cathode active material particle precursor for a lithium ion battery is desorbed to generate metal particles. As a result, the composite cathode active material particle precursor for a lithium ion battery becomes the composite cathode active material particles for a lithium ion battery described above, that is, the composite cathode active material particles for a lithium ion battery in which lithium alloy particles or metal particles are dispersed in the cathode active material.

When the lithium ion battery precursor having the cathode precursor layer is initially charged, lithium of the lithium alloy particles is consumed for forming SEI in the negative electrode. Consequently, when the lithium alloy particles contain at least one of Li₃Bi and Li₃Sb, the resulting cathode active material layers contain at least one of bismuth elemental particles and antimony elemental particles.

The initial charging condition may be a known condition.

The present disclosure will be described in detail with reference to Examples and Comparative Examples, but the present disclosure is not limited thereto.

### Preparation of a Lithium Ion Battery.

### Example 1

First, composite cathode active material particle precursor for a lithium ion battery including, as a cathode active material, 92.3 mg of LiNi_{0.8}Co_{0.1}Mn_{0.1}O₂(NCM811), and, as lithium alloy particles, 8.4 mg of Li₃Bi powder.

Specifically, Li₃Bi powder as lithium alloy particles was pulverized in an inert atmosphere. Then, a nickel hydroxide Ni(OH)₂ as a cathode active material was melted at 230° C., and the pulverized Li₃Bi powder was added thereto and dispersed, and the powder was cooled and solidified to obtain a precursor block. Next, the precursor block was pulverized, and the manganese compound, the cobalt compound, and the lithium source were mixed therein, and fired at 850° C. in an oxygen atmosphere for 15 hours to obtain a composite cathode active material particle precursor for a lithium ion battery. Here, by superimposing EDS mappings of SEM (Scanning Electron Microscopy) images and nickel (Ni) and bismuth (Bi), it was confirmed that the lithium alloy particles were dispersed in the cathode active material in the obtained composite cathode active material particle precursor. That is, it was confirmed that the lithium alloy particles were included in the cathode active material.

The active material particulate precursors, the conductive auxiliaries, and the binders were mixed in a NMP to form a slurry. This was applied to an Al foil as a positive electrode current collector layer and dried to obtain a cathode precursor layer.

The obtained cathode precursor layer was opposed to an anode active material layer containing graphite as an active material via a separator, vacuum-dried, and a nonaqueous electrolytic solution was put in to obtain a lithium ion battery precursor.

### Examples 2 to 3

Lithium ion battery precursors of Examples 2 to 3 were obtained in the same manner as in Example 1, except that the content of the cathode active material and the type and content of the lithium alloy particles were changed as shown in Table 1.

### Reference Examples 1 to 3

The lithium ion battery precursors of Reference Examples 1 to 3 were obtained in the same manner as in Examples 1 to 3, except that the same amount of cathode active material particles and lithium alloy particles were respectively used instead of the active material particle precursors.

### Evaluation

### Battery Capacity During Initial Charge/Discharge

Based on the mass of the cathode active material contained in the cell, the current value as 210 mA/g was defined as 1C rate, 0.2C was set as the charge-discharge current value, and 0.03C was set as the termination current value, and CCCV charge and CCCV discharge were performed. The upper limit voltage during charging was 4.25 V, and the lower limit voltage during discharging was 2.50 V. The obtained CCCV discharging capacity was defined as the capacity of the cell, and was used as the evaluation index of the present disclosure.

### Cycle Characteristics

After measuring cell capacitance, cycle test (CC charge/CC discharge, upper and lower limits 3 to 4.25 V, 0.3C rate) was carried out to determine the number of cycles until CC discharge capacity became 40% or less of the initial discharge capacity.

The configurations and evaluation results of the examples and comparative examples are shown in Table 1.

TABLE 1

| | | | | | | | | | | Evaluation results | | |
|---|---|---|---|---|---|---|---|---|---|---|---|---|
| | Configuration | | | | | | | | | Battery | | Number |
| | | | | | | | | Cathode | | capacity | | of |
| | | | | | | | | active | | (first | | cycles |
| | Cathode active material | | | Lithiums alloy particles | | | | materiał | | charge | | up to |
| | | Amount | | | Alloying | Amount | | layer | | discharge) | | capacity |
| | | contained | Volume | | potential V | contained | Volume | Volume | | Charge | Discharge | retention |
| | Type | (mg) | (cc) | Type | (vs Li/Li⁺) | (mg) | (cc) | (cc) | Inclusion | (mAh) | (mAh) | <40% |
| Reference | NCM811 | 92.3 | 0.0200 | Li₃Bi | 0.81 to | 0.84 | 0.0017 | 0.0217 | None | 25.0 | 22.1 | 26 |
| Example 1 | | | | | 0.83 | | | | | | | |
| Reference | NCM811 | 92.8 | 0.0202 | Li₂Sb | 0.94 to | 5.2 | 0.0015 | 0.0217 | None | 25.1 | 22.3 | 26 |
| Example 2 | | | | | 8.96 | | | | | | | |
| Reference | NCM811 | 87.3 | 0.0190 | LiSn | 0.57 to | 13.8 | 0.0027 | 0.0217 | None | 24.0 | 21.0 | 24 |
| Example 3 | | | | | 0.66 | | | | | | | |
| Example 1 | NCM811 | 92.3 | 0.0200 | Li₃Bi | 0.81 to | 8.4 | 0.0017 | 0.0217 | Y | 25.0 | 22.1 | 269 |
| | | | | | 0.83 | | | | | | | |
| Example 2 | NCM811 | 92.8 | 0.0202 | Li₃Sb | 0.94 to | 5.2 | 0.0015 | 0.0217 | Y | 25.1 | 22.3 | 260 |
| | | | | | 0.96 | | | | | | | |
| Example 3 | NCM811 | 87.3 | 0.0190 | LiSn | 0.57 to | 13.8 | 0.0027 | 0.0217 | Y | 24.0 | 21.0 | 263 |
| | | | | | 0.66 | | | | | | | |

From Table 1, we can see: In the lithium ion battery using the composite cathode active material particles for a lithium ion battery in which lithium alloy particles or metal particles are dispersed in the cathode active material, it is possible to suppress a decrease in capacity in a case where repeated charging and discharging are performed while suppressing a decrease in capacity after initial charging.

What is claimed is:

1. A composite cathode active material particle for a lithium ion battery, the composite cathode active material particle comprising:
a cathode active material; and
lithium alloy particles having a lithium alloying potential of 0.5 V (vs Li/Li⁺) or more and/or metal particles generated by desorption of lithium from the lithium alloy particles, wherein the lithium alloy particles or the metal particles are dispersed in the cathode active material.

2. The composite cathode active material particle according to claim 1, wherein the lithium alloy particles are selected from the group consisting of Li₃Bi, Li₃Sb, and LiSn.

3. The composite cathode active material particle according to claim 1, wherein the cathode active material is lithium nickel cobalt manganese oxide.

4. A cathode active material layer comprising the composite cathode active material particle according to claim 1.

5. A lithium ion battery comprising the cathode active material layer according to claim 4.

6. A method for manufacturing a lithium ion battery, the method comprising:
producing a composite cathode active material particle precursor for the lithium ion battery that contains a cathode active material and lithium alloy particles dispersed in the cathode active material and having a lithium alloying potential of 0.5 V (vs Li/Li⁺) or more;
producing a cathode precursor layer containing at least the composite cathode active material particle precursor for the lithium ion battery;
obtaining a lithium ion battery precursor including the cathode precursor layer, a separator or a solid electrolyte layer, and an anode active material layer in a stated order and impregnated with an electrolytic solution; and
performing initial charging of the lithium ion battery precursor to change the cathode precursor layer into a cathode active material layer.
